(19) United States
(12) Patent Application Publication
(10) Pub. No.: US 2022/0397552 A1
(43) Pub. Date: Dec. 15, 2022

(54) MOLECULAR IDENTIFICATION USING FIELD INDUCED FRAGMENTATION SPECTRA BY REACTIVE STAGE TANDEM DIFFERENTIAL MOBILITY SPECTROMETRY

(71) Applicant: GP Ionics LLC, Las Cruces, NM (US)

(72) Inventors: Gary Alan Eiceman, Las Cruces, NM (US); Peter Ernest Fowler, Las Cruces, NM (US)

(21) Appl. No.: 17/836,958

(22) Filed: Jun. 9, 2022

Related U.S. Application Data
(60) Provisional application No. 63/209,364, filed on Jun. 10, 2021.

(51) Int. Cl. G01N 27/624; G01N 1/40

(52) U.S. Cl. CPC G01N 27/624; G01N 1/4044

(57) ABSTRACT

A detector system comprises a first analytical stage configured to isolate ions from a sample, a field induced fragmentation stage configured to fragment the ions, a second analytical stage configured to characterize the ions, and at least one detector. The first analytical stage and the second analytical stage each comprise a differential mobility spectrometer. The field induced fragmentation stage comprises strips configured to create an electric field therebetween. In certain embodiments, the system further comprises a port configured between the first analytical stage and the field induced fragmentation stage, configured to introduce a reagent.

### CROSS REFERENCE TO RELATED PATENT APPLICATIONS

This application claims the priority and benefit under 35 U.S.C. § 119(e) of U.S. Provisional Patent Application Ser. No. 63/209,364 filed Jun. 10, 2021, entitled “MOLECULAR IDENTIFICATION USING FIELD INDUCED FRAGMENTATION SPECTRA BY REACTIVE STAGE TANDEM DIFFERENTIAL MOBILITY SPECTROMETRY” U.S.

Provisional Patent Application Ser. No. 63/209,364 is herein incorporated by reference in its entirety.

### STATEMENT OF GOVERNMENT RIGHTS

The invention described in this patent application was made with Government support under the Advanced Capabilities for Molecular Identification of Vapors with Reactive Multi-Stage Differential Mobility Spectrometry Contract Number IIP-1827525, awarded by the National Science Foundation. The Government has certain rights in the invention.

### TECHNICAL FIELD

Embodiments are generally related to ion mobility spectrometry (IMS) systems. Embodiments are further related to chemical measurements of volatile organic compounds. Embodiments are further related to sources of samples including, but not limited to, indoor air, mold, bacteria, breath, fragrances, and flavors. Embodiments are further related to other organic compounds which are semi-volatile or non-volatile and can be converted into gas phase ions. Embodiments are related to technologies at or near ambient pressure, often with purified air, but not limited to air or a specific operating pressure.

### BACKGROUND

Ion-mobility spectrometry (IMS) is a technique used to separate molecules as ions in the gas phase. IMS takes advantage of the various mobilities of ionized molecules in a carrier gas and electric field. IMS can be used to detect constituent molecules of samples and is therefore valuable in numerous applications including law enforcement, military, industrial safety and prevention, and security.

Mobility spectra for a substance are often comprised of a single peak, the result of soft ionization sources at or near ambient pressure. The chemical determination of substances using ion mobility spectrometers can be accomplished using this single peak according to the position, or drift time, of that peak in a mobility spectrum. A drift time of an ion in a weak electric field can be measured. The drift time is measured at peak maximum in a mobility spectrum, and when vapor concentrations are large, a second ion peak can be observed and drift time determined. The chemical identification of substances in IMS using a single peak, or two peaks from the substance, is problematic since other substances may have drift times measurably or nearly the same. Also, spectra in IMS analyzers operated at ambient pressure lack structural information necessary for reliable chemical identification. Consequently, the use of a drift time alone for one (or two) ions derived from the molecule is insufficient for the confident identification of molecules in ion mobility spectra.

Differential Mobility Spectrometry (DMS) is another ion mobility method where differences in mobilities of ions between high and low electric fields are used for ion characterization and separation. While drift time is used in conventional IMS with only low field mobility separation of ions, ion characterization in DMS is based on compensation voltages in the DMS analyzer. Differences in the principles of operation for DMS vs. conventional IMS translate into differences in practical implementation. A major advantage with the DMS method is the small size and simplicity possible with DMS analyzers.

Limitations on the usefulness of basic ion mobility systems have led to various improvements. For example, one approach includes the fragmentation of gas ions in electric fields of single IMS drift tubes. This technique involves fragmentation of ions with little or no control over which ion is fragmentated. As a result, there is undesirable complexity for controlling and understanding which fragment ion arises from which precursor ion. Another approach involves tandem mobility with ion selection using wire sets in large conventional mobility devices, for use with thermal modification of explosive ions. Conceptually, ion selection can be achieved using pulses of ions with two sets of wire grids, offset in timing, to isolate an ion based on drift time between the grid sets.

All such approaches are either insufficiently sophisticated to provide necessary chemical information about the identity of constituents of a sample or prohibitively complex and expensive. Accordingly, there is a need in the art for DMS systems and methods to measure gas ions in air at ambient pressure and provide molecular identification of a substances or assignment to a particular chemical family, which can be part of molecular identification.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

In an embodiment, systems and methods for molecular identification using field induced fragmentation by reactive stage tandem differential mobility spectrometry are disclosed. In certain embodiments, a substance is ionized conventionally, and ions are swept from the ion source into an analyzer.

Certain aspects of the new DMS embodiments include a first DMS or mobility stage used to mobility select and isolate an ion, and pass the ion to a second stage (all other ions are eliminated in this first stage by collision on the walls of the analyzer).

The analyzer can also include a second stage where the ion is transformed using chemical reactions which include fragmentation in strong electric fields (with or without assistance of temperature or photons). The fragmentation of ions in air at ambient pressure results in neutral and charged parts of the original ion. In this second stage, reagents or chemicals can be introduced before or after the region of strong field to create reactions with ions for further increase knowledge of the ion identity. All ions are passed into a third stage.

In the third stage, another DMS mobility analyzer analyzes the fragment ions and the original ion producing a Field Induced Fragmentation (FIF) spectrum. These FIF spectra are characteristic of chemical classes and introduce structural information into DMS mobility spectra which then can be used for identification of chemicals.

In certain embodiments, chemical identification can be made through artificial intelligence using neural networks with whole FIF spectra or via other methods with compensation voltage of fragment ions.

It is noteworthy that all processes can be accomplished at ambient pressure. However, in an exemplary embodiment isobaric control of the inner gas volume (for example, 600 torr) regardless of location is selected for optimal control of fragmentation processes and mobility analyses.

It is, therefore, an aspect of the disclosed embodiments to provide a reactive stage tandem DMS system comprising two plates in a flow of gas, the plates further comprising: a first DMS stage, a reactive middle stage, a second DMS analyzer stage, and at least one detector.

Furthermore, with data analysis of FIF spectra, entire spectra, rather than a single compensation voltage, are used with neural networks to extract from spectra features and details of a mobility measurement. The reactive stage tandem DMS thus produces increases in confidence and reliability for molecular identification from the production of fragment ions and the extraction of subtle spectra detail using artificial intelligence to give further structural information.

For example, in certain embodiments, a detector system comprises a first analytical stage configured to isolate ions from a sample, a field induced fragmentation stage configured to fragment the ions, a second analytical stage configured to characterize the ions, and at least one detector. In an embodiment, the first analytical stage and the second analytical stage each comprise a differential mobility spectrometer. In an embodiment, the field induced fragmentation stage comprises: a first strip and a second strip configured to create an electric field therebetween. In an embodiment, the system further comprises a port configured between the first analytical stage and the field induced fragmentation stage, configured to introduce a reagent. In an embodiment, the system comprises an air purifier configured to purify a gas carrier for the sample, before the sample is delivered to the first analytical stage. In an embodiment, the system comprises a driver configured to control an electric field of the field induced fragmentation (FIF) stage. In an embodiment, the detector comprises one of a faraday plate or a mass spectrometer. In an embodiment, the detector output comprises a spectra sufficient for chemical identification. In an embodiment, the spectra is analyzed using a neural network classification in order to identify constituent chemicals.

In another embodiment, a tandem differential mobility spectrometer comprises a first wafer configured with: a first wafer first DMS plate, a first wafer FIF strip, a first wafer second DMS plate, and a first wafer detector plate; a second wafer configured with: a second wafer first DMS plate, a second wafer FIF strip, a second wafer second DMS plate, and a second wafer detector plate; a gasket between the first wafer and the second wafer; and a frame configured to hold the first wafer and the second wafer. In an embodiment, the first wafer first DMS plate and the second wafer first DMS plate in combination form a first differential mobility spectrometer; the first wafer FIF strip and the second wafer FIF strip in combination form a field induced fragmentation stage; the first wafer second DMS plate and the second wafer second DMS plate in combination form a second differential mobility spectrometer; and the first wafer detector plate and the second wafer detector plate in combination form a detector. In an embodiment the tandem differential mobility spectrometer further comprises a port configured to introduce a vapor between the first differential mobility spectrometer and the field induced fragmentation stage.

In another embodiment, a chemical analysis method comprises isolating an ion from a sample with a differential mobility spectrometer, fragmenting the ion with an excitation stage, characterizing the ion with a second differential mobility spectrometer, and detecting the characterized ion with a detector. In an embodiment, fragmenting the ion further comprises establishing an electric field in the excitation stage. In an embodiment, establishing the electric field further comprises creating a potential difference between a first strip and a second strip in the excitation stage. In an embodiment, the chemical analysis further comprises introducing a gas flow between the differential mobility spectrometer and the excitation stage. In an embodiment, the chemical analysis further comprises providing energy at the excitation stage via an electric field, in order to facilitate a displacement reaction. In an embodiment, the chemical analysis method further comprises identifying a chemical from spectra provided by the detector. In an embodiment, identifying the chemical further comprises analyzing the spectra with a trained neural network.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1A illustrates a block diagram of a reactive stage tandem DMS, in accordance with the disclosed embodiments;

FIG. 1B illustrates an exemplary PCB associated with a reactive stage tandem DMS, in accordance with the disclosed embodiments

FIG. 1C illustrates a block diagram of a reactive stage tandem DMS, in accordance with the disclosed embodiments;

FIG. 2 illustrates a method for molecular identification, in accordance with the disclosed embodiments;

FIG. 3A illustrates a block diagram and method associated with a reactive stage tandem DMS, in accordance with the disclosed embodiments;

FIG. 3B illustrates a block diagram and method associated with a reactive stage tandem DMS, in accordance with the disclosed embodiments;

FIG. 4 illustrates a chart showing spectrum for protonated monomer of hexanal and spectrum for hexanal after the protonated monomer is mobility isolated, fragmented, and mobility analyzed, in accordance with the disclosed embodiments;

FIG. 5 illustrates a chart of field induced mobility spectra of n-hexanal at field strengths (E/N), in accordance with the disclosed embodiments;

FIG. 6 illustrates an exemplary chart of ion intensity, chromatographic retention time, and DMS compensation voltage taken with a reactive stage tandem DMS analyzer, in accordance with the disclosed embodiments;

FIG. 7A illustrates steps associated with fragment formation for butanal, in accordance with the disclosed embodiments;

FIG. 7B illustrates steps associated with fragment formation for butanal, in accordance with the disclosed embodiments;

FIG. 8 illustrates an exemplary chart showing a pathway for aldehydes undergoing fragmentation to ions characteristic of aldehydes over the range from carbon numbers 4 to 9, in accordance with the disclosed embodiments;

FIG. 9 illustrates an exemplary chart showing a pathway for alcohols undergoing fragmentation to ions characteristic of alcohols over the range from carbon numbers 3 to 8, in accordance with the disclosed embodiments;

FIG. 10 illustrates a chart showing shared fragment ions from each chemical family, visible in FIF spectra, characteristic of a chemical family, in accordance with the disclosed embodiment;

FIG. 11 illustrates an exemplary radar chart for chemical identification from FIF spectra in accordance with the disclosed embodiments;

FIG. 12 depicts a block diagram of a computer system which is implemented in accordance with the disclosed embodiments;

FIG. 13 depicts a graphical representation of a network of data-processing devices in which aspects of the present embodiments may be implemented;

FIG. 14 depicts a computer software system for directing the operation of the data-processing system depicted in FIG. 12, in accordance with an example embodiment; and

FIG. 15 depicts spectra from electric field promoted reactions, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or” as used herein may include a variety of meanings that may depend at least in part upon the context in which such terms are used. Typically, “or” is used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Systems and methods for molecular identification using field induced fragmentation by reactive stage tandem differential mobility spectrometry are disclosed herein. Conceptually, the disclosed embodiments take advantage of the fact that air at ambient pressure fragments ions from an electrically excited protonated monomer, decompose to chemical class specific ions. The fragmented ions from a mobility isolated peak are characteristic of the chemical family. Likewise, fragmented ions from a mobility isolated peak (i.e., Field Induced Fragmentation spectra) can provide molecular identity of a substance. Thus, the disclosed embodiment are configured for ion fragmentation used to class specific ions in air at ambient pressure.

In accordance with the disclosed embodiments, Differential Mobility Spectrometry (DMS), can be used in chemical measurements and are based on formation of ions derived from a sample, and the characterization of these ions in electric fields and supporting gas atmospheres. Supporting atmospheres may include air, nitrogen, and combinations of gases including hydrogen and helium at pressures ranging from a few torr to ambient pressure. The characterization of gas ions in electric fields is based on speed of ion swarms and establishes a measure of the identity of substances in a sample. Substance identities then may be used to extract the information on the composition of a sample.

Ion characterization in DMS occurs in an oscillating asymmetric electric field through differences, at extremes of the applied field, in the ion mobility coefficients that become field-dependent in strong fields. According to aspects disclosed herein, for DMS measurement, ions are carried in a flow of gas through the oscillating field, also known as the separation field, which can be of any strength, but in certain embodiments, may exceed 10,000 V/cm. The field can be established between two parallel plates with a narrow gap or channel for gas and ion flow. Field-dependent mobilities create off-axis displacement of ions and a correcting field is applied to reposition ions to the center of the gap where they pass to a Faraday plate, mass spectrometer, or other detector to record a signal. A scan of the correcting or compensation field (sometimes expressed as voltage) produces a measure of all ions in the DMS analyzer, a differential mobility spectrum, which provides a chemical measurement of a sample.

In the reactive stage tandem DMS, reagents or other chemicals can be added into the reactive volume, before or after the region of ion field excitation, to produce new ions through chemical reactions. These reactions can aid either in chemical identification or in selectivity of detection.

Accordingly, in certain embodiments, ion selection is achieved without wire grids and in small planar DMS structures, so that all other ions are excluded from further measurements. In certain embodiments, a strong field between two planar strips which are located between two DMS structures and on the same planes as the two DMS structures is used to achieve ion fragmentation. In certain embodiments, a homogeneous field can be used.

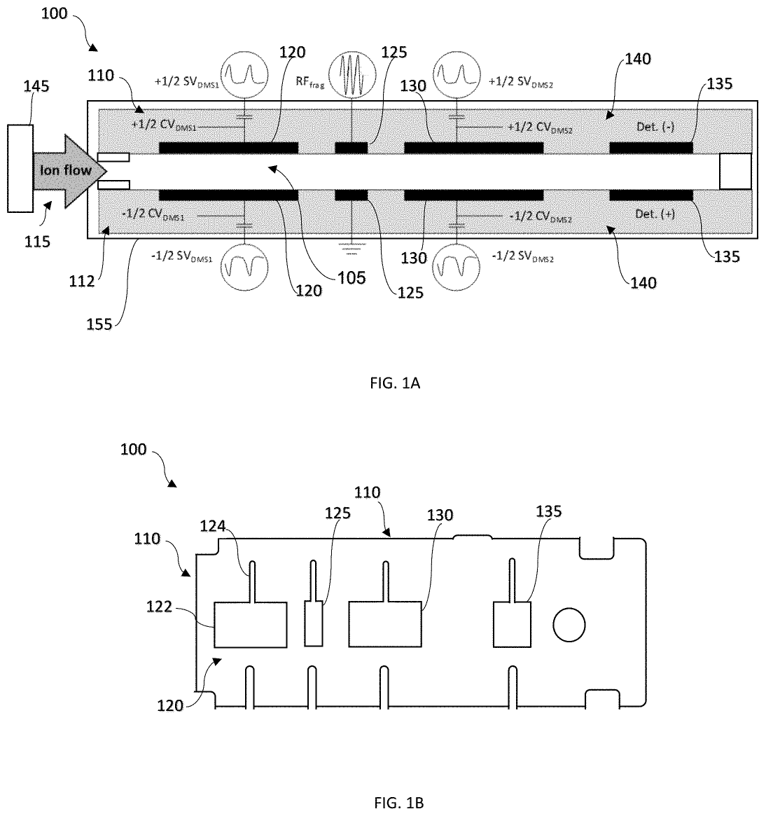

FIG. 1A depicts the structure of a reactive stage tandem DMS system 100, in accordance with the disclosed embodiments. As illustrated, ions pass through the gap 105 between two plates, first plate 110 and second plate 112, in a flow of gas 115. The plates 110 and 112, in combination can comprise four stages including a first DMS stage 120, a reactive middle stage 125, another DMS analyzer stage 130, and detector 135.

The first DMS or mobility stage 120 can be used to mobility select and isolate ions and pass the ions to a second stage. All other ions are eliminated in this first stage by collision on the walls 140 of the analyzer system 100.

The first DMS stage 120 can comprises a top and bottom base metal strip or film 122 (for example copper, or other such conductor) bonded to a ceramic plates 110 and 112 respectively. FIG. 1B illustrates an exemplary embodiment of plate 110 or 112. The strip can be coated with a thin film of gold. In certain embodiments, the overall dimensions of the strip 122 can be on the order of 5 mm wide by 8 mm long, although in other embodiments other sizes are possible. Note, all dimensional descriptions are exemplary and other sized elements can be used. An electrical connection 124 to the first DMS stage 120 can be made using a trace that extends from the stage 120 and ends at the end of the ceramic plate 110 or 112 respective, where a wire can be added by solder or press connection.

In certain embodiments, gas flow into the first DMS stage 120 and/or vapor reagent stage can be air or nitrogen passed through a molecular sieve 145 for purification and control of moisture. In an exemplary embodiment, gas carrying ions can flow into the first DMS stage 120 at a nominal rate of 0.8 to 1 L/min, although in other embodiments, other gas flow rates are possible.

In the second stage 125, the ion can be transformed using chemical reactions which include fragmentation in strong electric fields (with or without assistance of temperature or photons). The fragmentation of ions in air at ambient pressure results is neutral and charged parts of the original ion. In the second or reactive stage 125 of the tandem DMS system 100, displacement reactions which are favorable or unfavorable in enthalpy may be achieved using energy from the electric field of the reactive stage. For example, an endothermic displacement reaction with proton bound dimers of organophosphorous compounds (OPCs) and isopropanol (IPA) can be enabled in air at ambient pressure by ion heating in a reactive middle stage 125. Proton bound dimers (M₂H⁺) can be mobility isolated in purified air with the first DMS stage 120, mixed with IPA at 100 ppm in a middle reactive stage 125 at 106 to 160 Td with a symmetrical 4 MHz waveform, and mobility analyzed in a second DMS stage. It should be appreciated that, more generally, the reactive stage 125 can be used to realize reactions of numerous types, without departing from the scope disclosed herein.

The second stage 125 can be followed by a port 150 where reagents, vapor modifiers, or other substances are introduced to the flow of gas and ions. The port 150, as illustrated in FIG. 1C can comprise an opening in the plate. In exemplary embodiments, gas with reagent vapor is introduced into the port 150 for vapor reagent at 0.1 to 0.3 L/min at vapor concentrations between 10 and 30,000 ppm of reagent.

In certain exemplary embodiments, the port 150 opening can be 1 mm wide by 5 mm long, but other dimensions are also possible. The port 150 opening is connected pneumatically to channels and fittings in the body of the analyzer system 100. Flow of reagents or chemicals under slight pressure can be added to the analyzer body 155 and then, through channels to the port 150, and finally into the flow 115 of the analyzer system 100. Flow rates of gases carrying reagents can range from a few milliliters/min to more than 100 ml/min. The port 150 can be located between the FIF stage 125 and the second DMS mobility analyzer stage 130. All ions are passed into a third stage 130.

In the third stage 130, another DMS mobility analyzer analyzes the fragment ions and the original ion producing a Field Induced Fragmentation (FIF) spectrum. These FIF spectra are characteristic of chemical classes, and introduce structural information into the DMS mobility spectra, which can be used for identification of chemicals. It should be noted that this DMS mobility analyzer 130 and the detector 135 that follows, can be identical to that of the first DMS stage 120 in configuration. The detector 135 can be slightly smaller than the DMS stages with a 5 mm length and a ceramic plate of roughly 1 mm thickness.

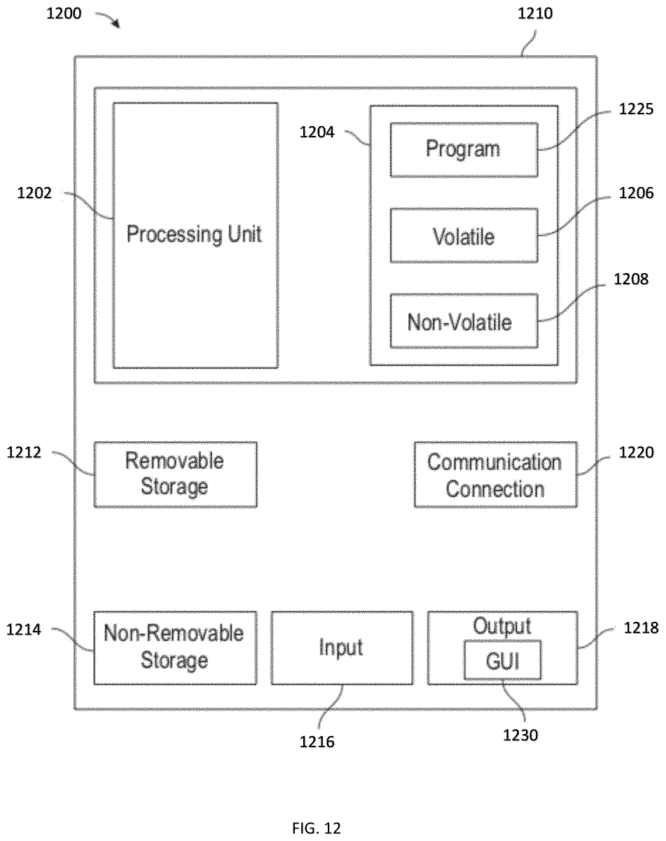

In an exemplary embodiment, the detector 135 can comprise a set of faraday plates biased at ±5 V to detect ions colliding with them. This signal can be amplified approximately 5*10⁹ times (or other such amplification) and passed through an analog to digital converter for collection and display on a computer interface. The computer interface can comprise an interface as illustrated in FIGS. 12-14.

In certain embodiments, chemical identification can be made through artificial intelligence using neural networks with whole spectra, FIF spectra, or via other methods with compensation voltage of fragment ions.

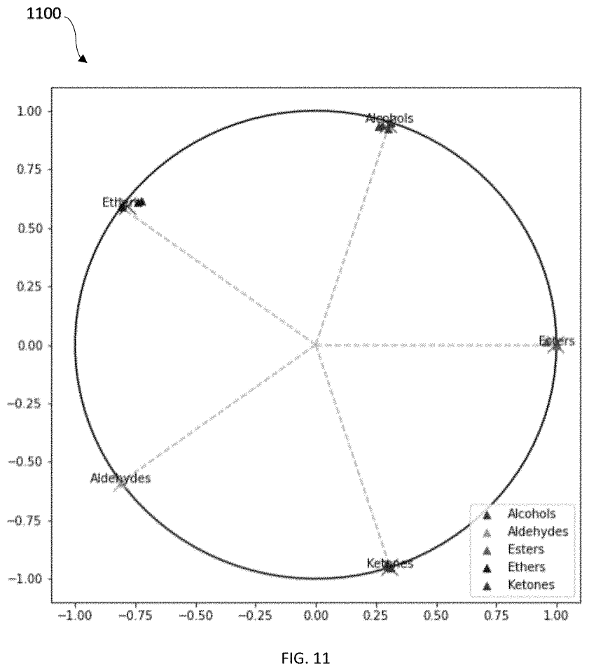

Results from neural network identification of chemicals by chemical class are illustrated in FIG. 11. The Radar chart 1100 shows Neural Network classification for familiar chemicals measured with FIF spectra in reactive multi-stage tandem DMS, such as system 100.

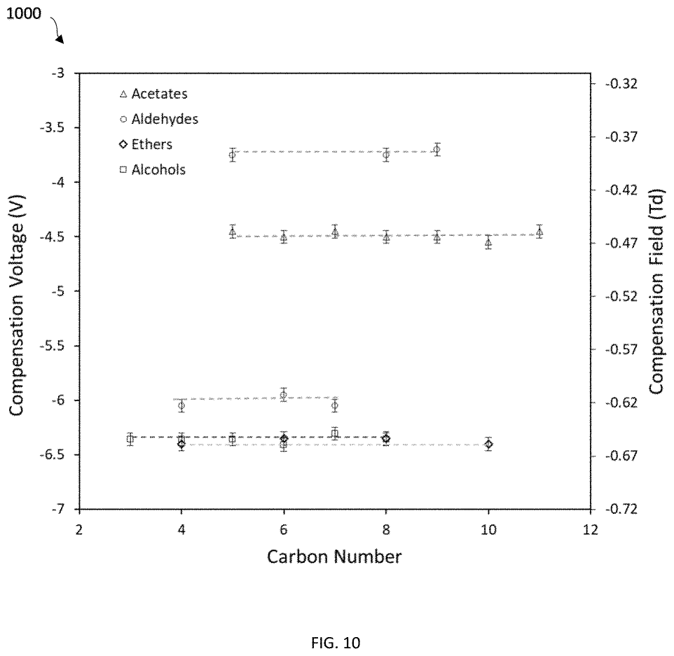

In certain embodiments, a neural network can be trained across a library of known spectra for the families shown in FIG. 10 (for example), after which the trained neural network is challenged with spectra not available in the training set. Each spectrum is assigned a probability of identity for each of the chemical families present in the training set, with all probabilities summing to 1. These probabilities are summed across many spectra for an individual chemical species and plotted on a radar chart 1100 as shown in FIG. 11. Each triangle is a distinct chemical species, arranged by chemical family with the center of mass of all compounds in that family shown by an associated X.

A trained neural network can be assessed by two challenges. In the first, previously excluded spectra from a chemical species present in the training set are presented to the network and assigned probabilities of identity. These spectra are from chemicals which can be termed “familiar” to the network. This method of challenge works well for limited databases with known samples, but the neural network is not solely using the underlying structural chemical information, and can rely on secondary features.

In the second, spectra from a chemical species not included in the training set are presented to the network and assigned probabilities of identity. These spectra are from a chemical species which can be termed “unfamiliar” to the network. This method of challenge probes the robustness of the neural network and the features it is using to assign probability, constraining the possible information for correct assignment of identity to shared structural chemical features such as shared fragment ions, not secondary or unrelated spectral patterns.

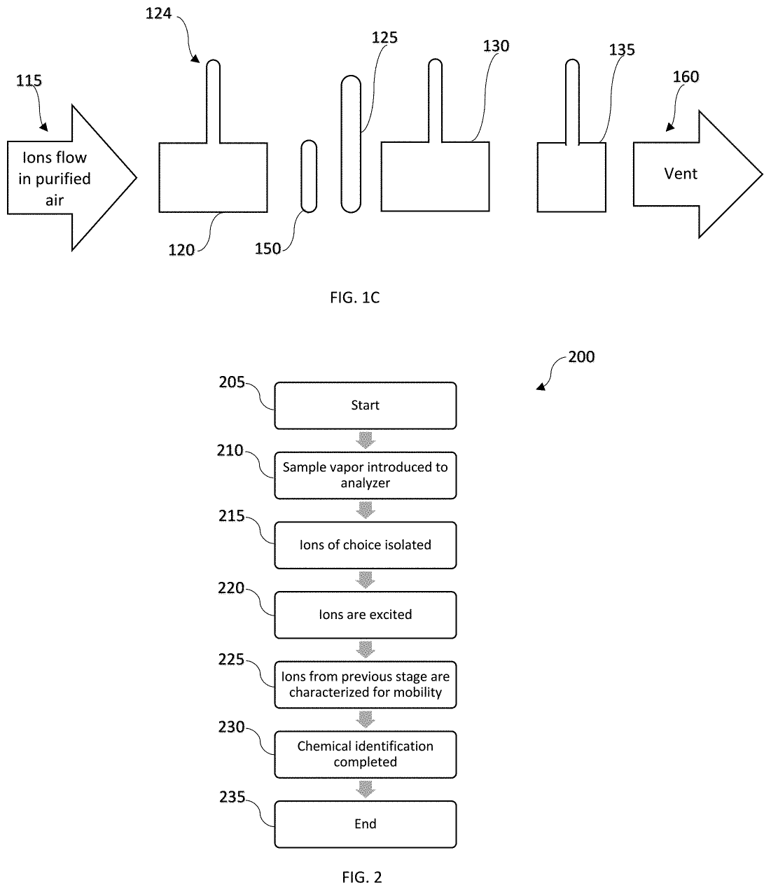

FIG. 1C illustrates another exemplary embodiment of a reactive stage tandem DMS system 100, which can implement a method as illustrated in FIG. 2. As illustrated, ions flow into the system in purified air.

The ionized gas enters the first mobility stage (DMS1) 120. The first and last mobility stages (DMS1 120 and DMS2 130 respectively), can be separated by a region for ion fragmentation or ion heating by electric field. In this region, or middle stage 125, there is also a port 150 with a reagent, located before (or after) the strip for high field heating of gas ions. This introduces the opportunity to transform ions chemically using energy from the strip, or even without additional energy. For example, fragment ions can be further reacted with vapors to form selectively new ions that improve ion identification. The ions are detected at the detector stage 135 and a vent 160 allows the associated gas flow to exit the system.

The port 150 where reagents, vapor modifiers, or other substances are introduced to the flow of gas and ions can comprise an opening in the plate. In certain exemplary embodiments the opening can be 1 mm wide by 5 mm long, but other dimensions are also possible. The opening is connected pneumatically to channels and fittings in the body of the analyzer. Flow of reagents or chemicals under slight pressure can be added to the analyzer body and then, through channels to the port, and finally into the flow of the analyzer. Flows of gases carrying reagents can range from a few milliliters/min to more than 100 ml/min. The port can be located also between the fragmenter strip 125 and DMS2 130.

In certain embodiments, the system disclosed above can be used for chemical analysis as illustrated in the method 200. The method starts at 205. As shown at 210 a sample vapor is introduced into the analyzer system 100, where gas phase chemical reactions produce ions derived from constituents of the sample. The first analytical stage of the disclosed differential mobility spectrometer is used to isolate an ion of choice at step 215. All other ions are removed from the measurement.

The ion of choice is passed into second stage where a strong electric field is established. In exemplary embodiments, the second stage electric fields, can range from 0 to 160 Td or above, constrained by the breakdown voltage between the two plates, and at frequencies from 1 to 6 MHz, typically at 4 MHz. In other embodiments, other field parameters can be selected according to design considerations.

In this strong electric field, the selected (and isolated) ion undergoes excitation as illustrated at 220. When the field is strong enough, ions can fragment, or break bonds; a process known as field induced fragmentation (FIF). All processes occur at ambient pressure in, for example, an air or nitrogen gas atmosphere. Ions formed during FIF are chemical class specific and are characteristic of a chemical family, and different from other chemical families. Ions are passed from the second reactive stage of the system to a third stage where the ions from FIF are characterized for mobility in a differential mobility analyzer just like the first stage, as shown at step 225. Chemical identification can then be completed with a detector at step 230. The method ends at step 235.

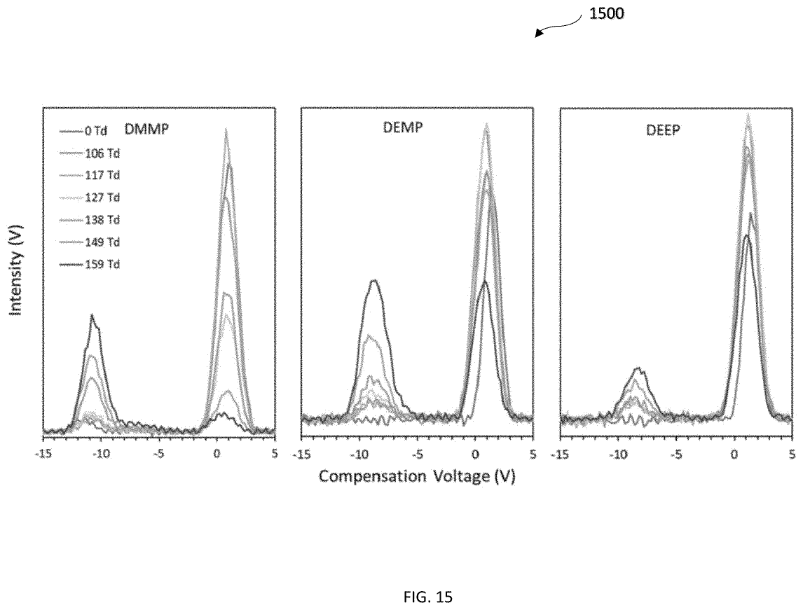

FIG. 15 provides chart 1500 of exemplary spectra from electric field promoted reactions for DMMP, DEPM, and DEEP in IPA at waveform amplitudes 0 to 3000 V (0 to 159 Td) according to the disclosed methods and systems.

The disclosed system 100 is capable of molecular identification unlike any other DMS based analyzer. The system 100 is further unique in that reagents can be mixed in the reactive stage and can be driven to chemical reactions using the electric field to push ions and reactants over an activation energy.

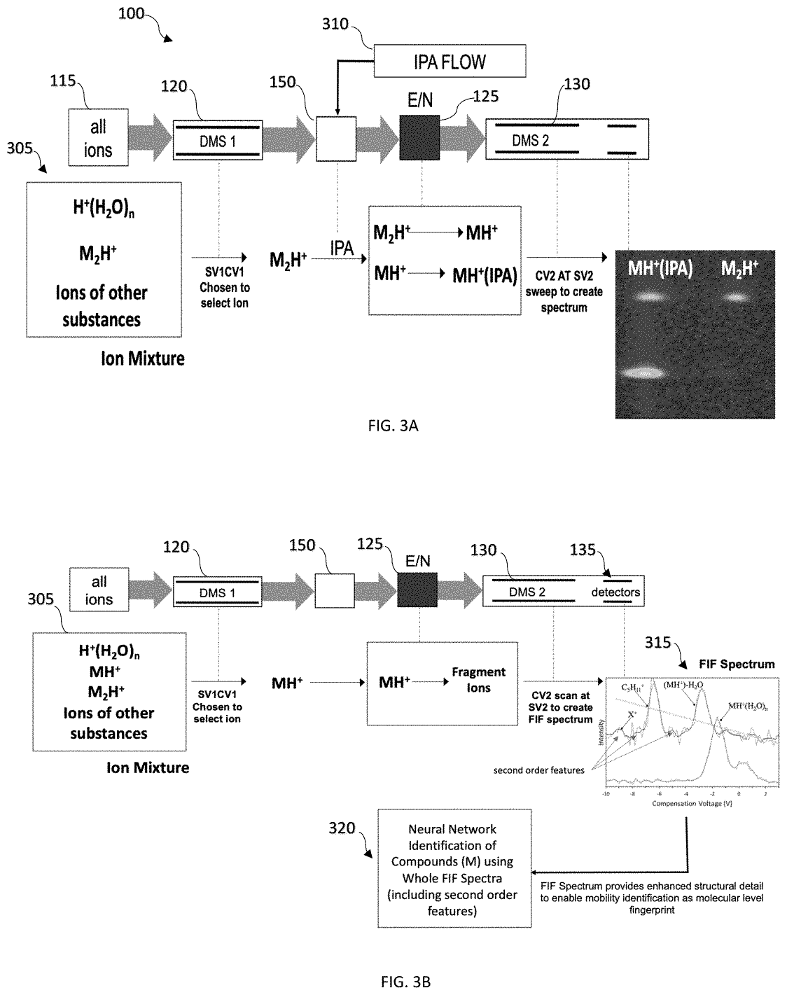

It should be appreciated that the disclosed reactive stage tandem DMS system 100 can operate according to two mechanisms. FIGS. 3A and 3B illustrate block diagrams of a system 100 and associated method for compound identification, underscoring the two operating principles of the second or active stage of the reactive stage tandem DMS system 100.

As illustrated in FIG. 3A, an ion mixture 305 can flow into the first DMS stage 120. In the first DMS stage 120 ions are mobility selected and isolated and then passed to the active, FIF, or second stage 125. In the embodiment illustrated in FIG. 2A, the core principle is illustrated—a reagent 310 can be added to the reactive tandem system 100 to create new chemistry. This is accomplished via a port 150 where reagents, vapor modifiers, or other substances are introduced to the flow of gas and ions. The resulting ions are then passed through the second DMS stage 130 where a sweep is completed to create a spectrum which can be used for compound identification.

The system 100 illustrated in FIG. 3B is similar in most respects. However, as illustrated in FIG. 3B, after the first DMS stage 120 where ions are mobility selected and isolated, the additional reagents are not required. Instead, in the second or active stage 125, a fragmenter breaks apart the ions creating ion fragments. These ion fragments can then be scanned in the second DMS stage 130, and a detector 135 in the last stage is used to create an FIF spectra 315. The FIF spectra 315 can then be provided to a neural network 320, or other such computer system for analysis. Artificial intelligence algorithms, as detailed herein, can be used to identify the compounds using the whole FIF spectra 315.

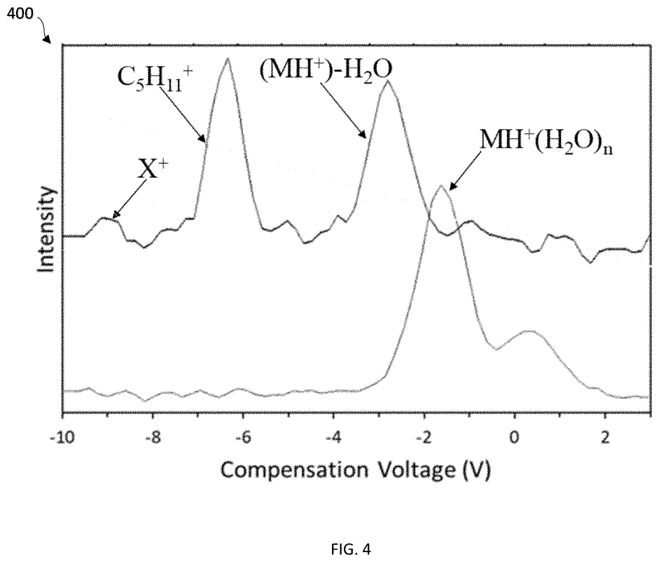

FIG. 4 illustrates the spectrum 400 for a protonated monomer of hexanal (red line) and spectrum for hexanal after the protonated monomer was mobility isolated, fragmented, and mobility analyzed (blue). Structural information is introduced from field fragmentation where ion assignments are shown and peak X+ is likely C₃H₅⁺ a third level fragment. This structural information enables molecular identification.

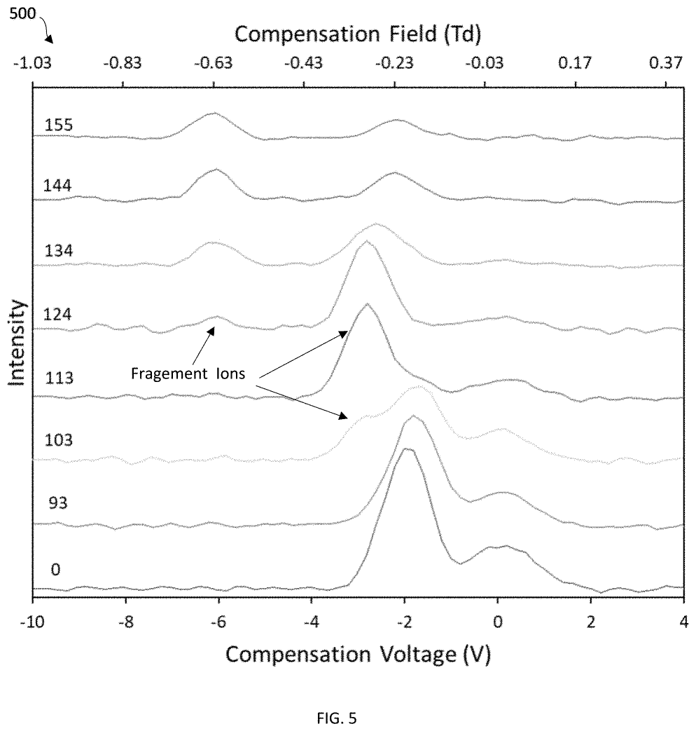

FIG. 5 shows eight field induced mobility spectra 500, of n-hexanal at field strengths (E/N) from 0 to 155 Td. At E/N from 103 TD to 124 Td, the principal process is dissociation of the proton bound dimer to a protonated monomer with some fragmentation to an unsaturated carbocation. At E/N 134 Td and above, a secondary level of fragmentation occurs with the loss of ethene forming a butene carbocation at CV of −6 V.

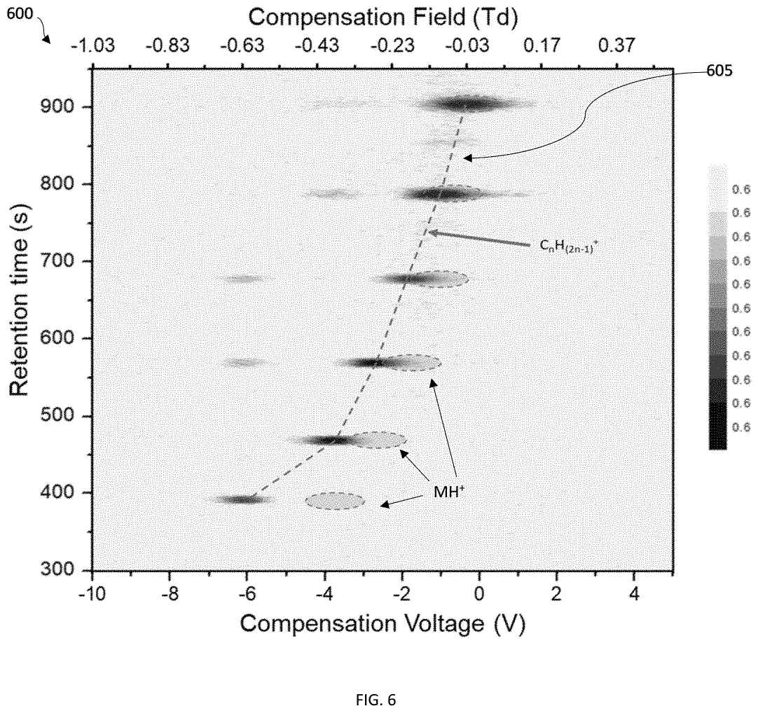

FIG. 6 provides a chart 600 that depicts the formation of fragment ions from a homologous series of n-aldehydes from gas chromatograph analysis with a reactive stage tandem DMS analyzer as detector in accordance with the disclosed embodiments. Results are shown as a plot 605 of ion intensity, chromatographic retention time, and DMS compensation voltage from analysis of mixture of n-aldehydes (n-butanal to n-nonanal) with mobility isolation of protonated monomers in DMS1 120, ion fragmentation in reactive stage 125 (at 129 Td), and CV scanning in DMS 2 130. The shaded ellipses show the location of mobility isolated protonated monomers.

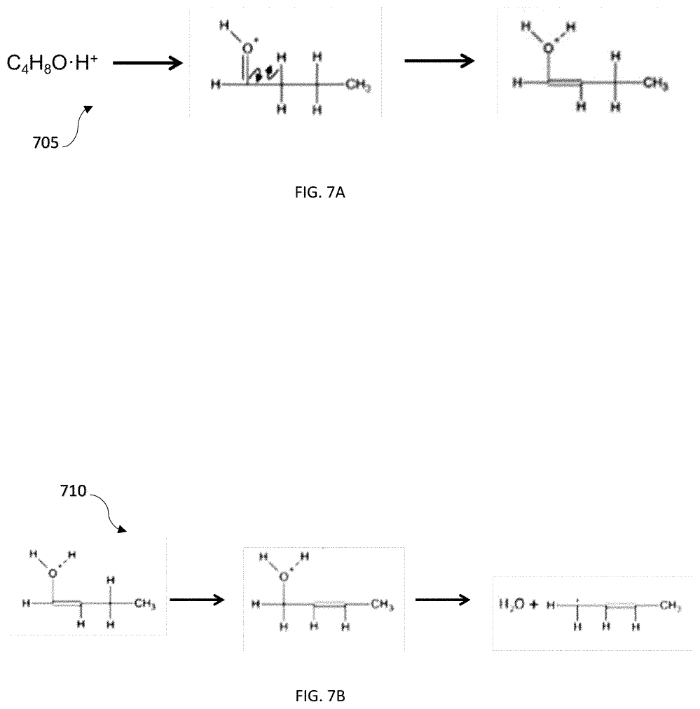

Exemplary field fragmentation is shown in process chart 705 in FIG. 7A and process chart 710 in FIG. 7B. The fragments can be formed by field induced fragmentation in the reactive stage through a rearrangement reaction with a strained four-member ring transition state (shown as “TS”, in FIG. 7A). Thus, the intense ions shown in FIG. 6 arose from field induced heating of ions with bond migration and dehydration to an unsaturated carbocation, C₄H₇⁺ for n-butanal shown in FIG. 7B. The patterns of these fragment ions indicate complete fragmentation at 129 Td for protonated monomers from n-butanal to n-heptanal. This measures for completeness of fragmentation for n-octanal and n-nonanal since peaks convolve for protonated monomer and fragment ion.

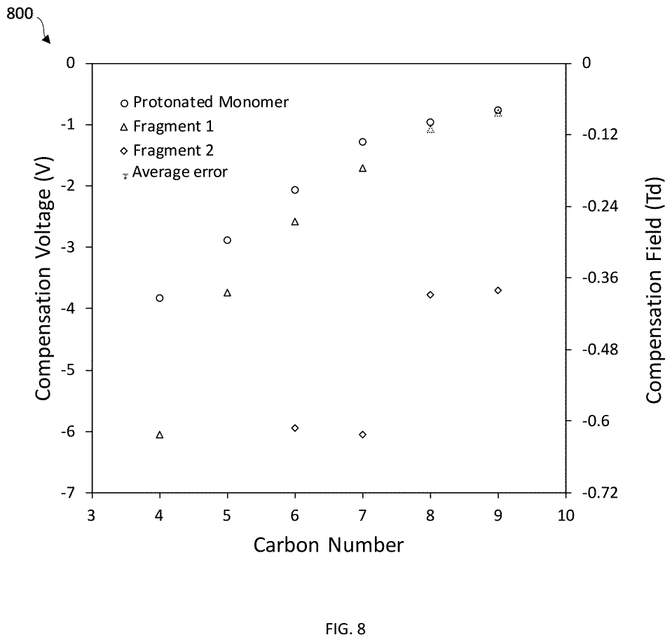

FIG. 8 shows another view of key content in spectra where the pattern of fragment ion formation for aldehydes is shown in a plot 800 of mobility behavior versus carbon number. Protonated monomers are shown as unfilled circles and the first fragment ion (unsaturated carbocations) are shown with unfilled triangles. Evidence of class specific fragmentation is seen in ions with carbon numbers 8 and 9, which fragmented to an ion at −4 V and carbon numbers 4, 6 and 6 which fragmented to ca −6V. These ions are from a second level of fragmentation with a loss of a neutral alkene are shown as unfilled squares. Further increase in field strength to further heat ions lead to smaller ion still.

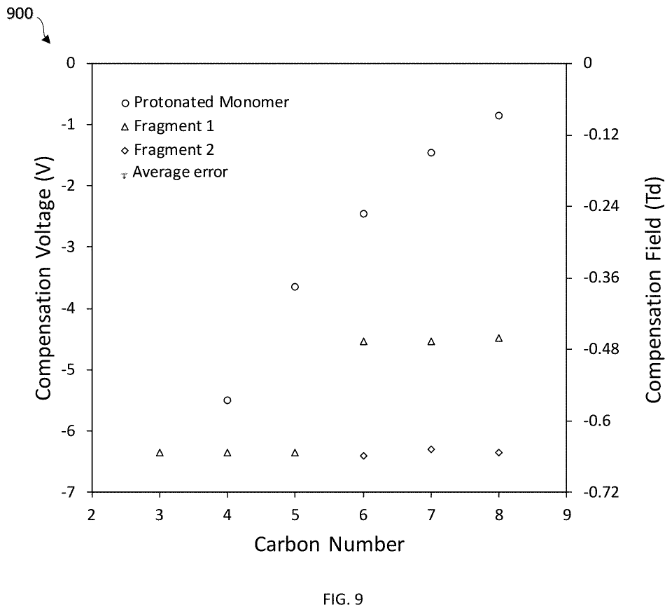

FIG. 9 provides a chart 900 that shows alcohols undergo fragmentation to ions characteristic of alcohols over the entire range from carbon numbers 3 to 8. This is the core concept of molecular identification with reactive stage tandem DMS.

FIG. 10 shows a summary 1000 of studies where ions from each chemical family, formed in FIF spectra are characteristics of a chemical family. According to the embodiments, disclosed herein, these ions can be correlated to mass analysis showing commonality for small fragments from alcohols aldehydes and acetates. TABLE 1 illustrates ions and ion fragments by compound and chemical family.

TABLE 1

| | Proton | | | | | |
|---|---|---|---|---|---|---|
| | Bound | Protonated | First Level | | Second Level | |
| Compounds | Dimer | Monomer | Fragment Ion | | Fragment Ion | |
| Alcohols | M₂H⁺(H₂O)ₙ | MH⁺(H₂O)ₙ | (MH⁺)—H₂O | (MH⁺)—H₂ | C₅H₁₁⁺ | C₄H₉⁺ |
| 1-Propanol | −28% | 1% | −3% | 28% | — | — |
| 1-butanol | −1% | −14% | 14% | — | — | — |
| 1-pentanol | −3% | −14% | 15% | — | — | — |
| 1-hexanol | 4% | −15% | 14% | — | — | — |
| 1-heptanol | 13% | −18% | −5% | — | — | 12% |
| 1-octanol | 8% | −16% | −1% | — | 3% | 7% |
| 2-Propanol | −10% | −2% | −3% | 17% | — | — |
| Iso-butanol | −22% | 8% | 20% | — | — | — |
| 2-butanol | −29% | 9% | 23% | — | — | — |
| Cyclohexanol | −14% | | 28% | — | — | — |
| | | | Unsaturated | | | |
| Aldehydes | M₂H⁺(H₂O)ₙ | MH⁺(H₂O)ₙ | carbocation | | C₅H₉⁺ | C₄H₇⁺ |
| Butanal | −24% | 4% | 20% | — | — | — |
| Pentanal | −15% | −17% | 31% | — | — | — |
| Hexanal | −1% | 3% | −14% | — | — | 12% |
| Heptanal | 17% | −26% | 6% | — | — | 4% |
| Octanal | 2% | −28% | 16% | — | 6% | — |
| Nonanal | 8% | −26% | 11% | — | 4% | — |
| Esters | M₂H⁺(H₂O)ₙ | MH⁺(H₂O)ₙ | | | C₂H₄O₂H⁺ | C₃H₄O₂H⁺ |
| Propyl Acetate | −27% | −11% | — | — | 37% | — |
| Butyl Acetate | 2% | −17% | — | — | 18% | — |
| Pentyl Acetate | −35% | 2% | — | — | 29% | — |
| Hexyl Acetate | 10% | −16% | — | — | 8% | — |
| Heptyl Acetate | 12% | −14% | — | — | 3% | — |
| Octyl Acetate | 12% | −16% | — | — | 4% | — |
| Nonyl Acetate | 22% | −24% | — | — | 2% | — |
| IsoPropyl Acetate | −24% | −15% | — | — | 38% | — |
| IsoButyl Acetate | −9% | −15% | — | — | 16% | — |
| IsoPentyl Acetate | 15% | −17% | — | — | — | — |
| Vinyl Acetate | −28% | −17% | — | — | 54% | — |
| Methyl Butyrate | −11% | 11% | — | — | — | — |
| sec-Butyl Acetate | −10% | −22% | — | — | 31% | — |
| Ethyl Acrylate | −20% | −30% | — | — | — | 48% |

The disclosed embodiments are thus directed to methods and system for chemical analysis. Electric field activated chemical reactions can be leveraged to transform ions into new substances in air at ambient pressure. Fragmentation of mobility isolated ions in strong electric fields and in planar structures at ambient pressure make the disclosed embodiments suitable to be advanced in new structures with new capabilities for ion chemistry.

The systems and methods detailed herein transform DMS from a selective detector to a molecular identifier, by leveraging the fact that ions at ambient pressure fragment to ions characteristic of their chemical class. This bridges a very large gap in chemical measurements and can be used in a wide variety of application.

Using the systems and methods disclosed herein, it is possible to determine the molecular identification of substances where prior approaches provide only selective detection of a substance without any confidence that a measurement can be assigned to a specific substance with confidence. In other words, chemical class characteristic ions generated in using the disclosed embodiments, add into the spectra the information needed for identification.

Further chemical information can be accessed by providing activation energy for chemical reactions via heating with strong electric fields. Dissociation, displacement, and other reactions which are chemically characteristic can be driven by this technology as a further source of chemical information.

The disclosed embodiments can be used for air quality monitoring for volatile organic compounds, measurement of metabolites in breath for diagnosis of illness or disease, analysis of fragrances and flavors, characterization of food for origin or purity, explosive analyses, chemical warfare analyses.

FIGS. 12-14 are provided as exemplary diagrams of data-processing environments in which embodiments of the present embodiments may be implemented. It should be appreciated that FIGS. 12-14 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments. The depicted embodiments can comprise the hardware and software systems necessary to implement a neural network and or to provide the artificial intelligence processing as disclosed herein.

A block diagram of a computer system 1200 that executes programming for implementing parts of the methods and systems disclosed herein is shown in FIG. 12. A computing device in the form of a computer 1210 configured to interface with controllers, peripheral devices, and other elements disclosed herein may include one or more processing units 12202, memory 1204, removable storage 1212, and non-removable storage 1214. Memory 1204 may include volatile memory 1206 and non-volatile memory 1208. Computer 1210 may include or have access to a computing environment that includes a variety of transitory and non-transitory computer-readable media such as volatile memory 1206 and non-volatile memory 1208, removable storage 1212 and non-removable storage 1214. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

Computer 1210 may include, or have access to, a computing environment that includes input 1216, output 1218, and a communication connection 1220. The computer may operate in a networked environment using a communication connection 1220 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 9 below.

Output 1218 is most commonly provided as a computer monitor, but may include any output device. Output 1218 and/or input 1216 may include a data collection apparatus associated with computer system 1200. In addition, input 1216, which commonly includes a computer keyboard and/or pointing device such as a computer mouse, computer track pad, or the like, allows a user to select and instruct computer system 1200. A user interface can be provided using output 1218 and input 1216. Output 1218 may function as a display for displaying data and information for a user, and for interactively displaying a graphical user interface (GUI) 1230.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 1216 such as, for example, a pointing device such as a mouse, and/or with a keyboard. A particular item can function in the same manner to the user in all applications because the GUI provides standard software routines (e.g., module 1225) to handle these elements and report the user's actions. The GUI can further be used to display the electronic service image frames as discussed below.

Computer-readable instructions, for example, program module or node 1225, which can be representative of other modules or nodes described herein, are stored on a computer-readable medium and are executable by the processing unit 1202 of computer 1210. Program module or node 1225 may include a computer application. A hard drive, CD-ROM, RAM, Flash Memory, and a USB drive are just some examples of articles including a computer-readable medium.

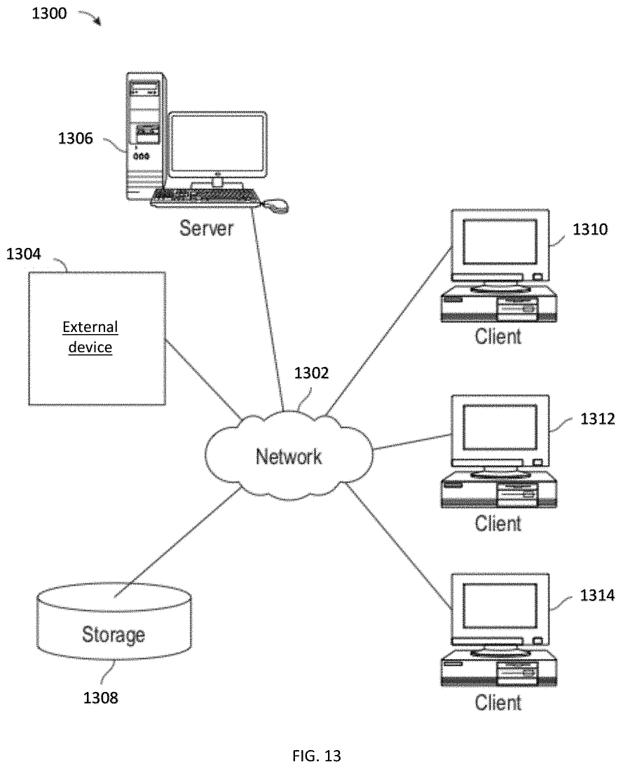

FIG. 13 depicts a graphical representation of a network of data-processing systems 1300 in which aspects of the present invention may be implemented. Network data-processing system 1300 can be a network of computers or other such devices, such as mobile phones, smart phones, sensors, controllers, actuators, speakers, “internet of things” devices, and the like, in which embodiments of the present invention may be implemented. Note that the system 1300 can be implemented in the context of a software module such as program module 1225. The system 1300 includes a network 1302 in communication with one or more clients 1310, 1312, and 1314. Network 1302 may also be in communication with one or more devices 1304, servers 1306, and storage 1308. Network 1302 is a medium that can be used to provide communications links between various devices and computers connected together within a networked data processing system such as computer system 1200. Network 1302 may include connections such as wired communication links, wireless communication links of various types, and fiber optic cables. Network 1302 can communicate with one or more servers 1306, one or more external devices such as device 1304, and a memory storage unit such as, for example, memory or database 1308. It should be understood that device 1304 may be embodied as a detector device, controller, receiver, transmitter, transceiver, transducer, driver, motor, some combination thereof, or other such device.

In the depicted example, device 1304, server 1306, and clients 1310, 1312, and 1314 connect to network 1302 along with storage unit 1308. Clients 1310, 1312, and 1314 may be, for example, personal computers or network computers, handheld devices, mobile devices, tablet devices, smart phones, personal digital assistants, controllers, recording devices, speakers, MFDs, etc. Computer system 1200 depicted in FIG. 12 can be, for example, a client such as client 1310 and/or 1312 and/or 1314.

Computer system 1200 can also be implemented as a server such as server 1306, depending upon design considerations. In the depicted example, server 1306 provides data such as boot files, operating system images, applications, and application updates to clients 1310, 1312, and/or 1314. Clients 1310, 1312, and 1314 and device 1304 are clients to server 1306 in this example. Network data-processing system 1300 may include additional servers, clients, and other devices not shown. Specifically, clients may connect to any member of a network of servers, which provide equivalent content.

In the depicted example, network data-processing system 1300 is the Internet, with network 1302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 1300 may also be implemented as a number of different types of networks such as, for example, an intranet, a local area network (LAN), or a wide area network (WAN). FIGS. 12 and 13 are intended as examples and not as architectural limitations for different embodiments of the present invention.

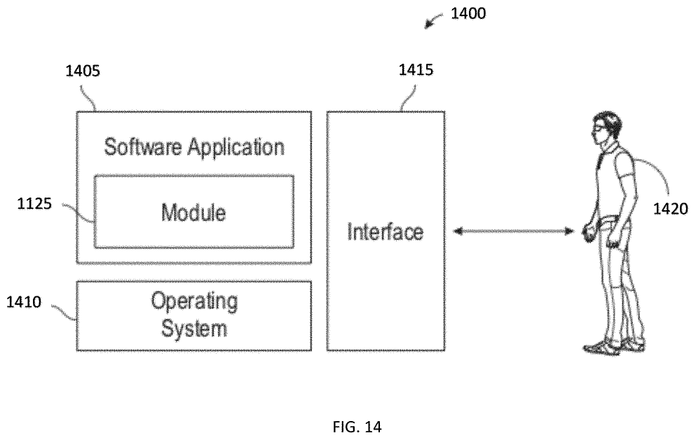

FIG. 14 illustrates a software system 1400, which may be employed for directing the operation of the data-processing systems such as computer system 1200 depicted in FIG. 12. Software application 1405, may be stored in memory 1204, on removable storage 1212, or on non-removable storage 1214 shown in FIG. 12, and generally includes and/or is associated with a kernel or operating system 1410 and a shell or interface 1415. One or more application programs, such as module(s) or node(s) 1225, may be “loaded” (i.e., transferred from removable storage 1214 into the memory 1204) for execution by the data-processing system 1200. The data-processing system 1200 can receive user commands and data through user interface 1415, which can include input 1216 and output 1218, accessible by a user 1420. These inputs may then be acted upon by the computer system 1200 in accordance with instructions from operating system 1410 and/or software application 1405 and any software module(s) 1225 thereof.

Generally, program modules (e.g., module 1225) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 1415 (e.g., a graphical user interface 1230) can serve to display results, whereupon a user 1420 may supply additional inputs or terminate a particular session. In some embodiments, operating system 1410 and GUI 1230 can be implemented in the context of a “windows” system. It can be appreciated, of course, that other types of systems are possible. For example, rather than a traditional “windows” system, other operation systems such as, for example, a real-time operating system (RTOS) more commonly employed in wireless systems may also be employed with respect to operating system 1410 and interface 1415. The software application 1405 can include, for example, module(s) 1225, which can include instructions for carrying out steps or logical operations such as those shown and described herein.

The following description is presented with respect to embodiments of the present invention, which can be embodied in the context of, or require the use of, a data-processing system such as computer system 1200, in conjunction with program module 1225, and data-processing system 1300 and network 1302 depicted in FIGS. 12-13. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Windows, Macintosh, UNIX, LINUX, Android, Arduino, LabView and the like. Therefore, the descriptions of the exemplary embodiments, which follow, are for purposes of illustration and not considered a limitation.

Based on the foregoing, it can be appreciated that a number of embodiments, preferred and alternative, are disclosed herein. For example, in an embodiment, a detector system comprises a first analytical stage configured to isolate ions from a sample, a field induced fragmentation stage configured to fragment the ions, a second analytical stage configured to characterize the ions, and at least one detector. In an embodiment, the first analytical stage comprises a differential mobility spectrometer. In an embodiment, the second analytical stage comprises a differential mobility spectrometer. In an embodiment, the field induced fragmentation stage comprises a first strip and a second strip configured to create an electric field therebetween.

In an embodiment, the detector system further comprises a port configured between the first analytical stage and the field induced fragmentation stage, configured to introduce a reagent. In an embodiment, the detector system further comprises an air purifier configured to purify a gas carrier for the sample, before the sample is delivered to the first analytical stage. In an embodiment, the detector system further comprises a driver configured to control an electric field of the field induced fragmentation stage.

In an embodiment, the detector comprises one of a faraday plate or a mass spectrometer. In an embodiment, an output from the detector comprises a spectra sufficient for chemical identification. In an embodiment, the spectra is analyzed using a neural network classification in order to identify constituent chemicals.

In another embodiment, a tandem differential mobility spectrometer comprises a first wafer configured with: a first wafer first DMS plate, a first wafer FIF strip, a first wafer second DMS plate, and a first wafer detector plate; a second wafer configured with: a second wafer first DMS plate, a second wafer FIF strip, a second wafer second DMS plate, and a second wafer detector plate; a gasket between the first wafer and the second wafer; and a frame configured to hold the first wafer and the second wafer.

In an embodiment, the first wafer first DMS plate and the second wafer first DMS plate in combination form a first differential mobility spectrometer the first wafer FIF strip and the second wafer FIF strip in combination form a field induced fragmentation stage, the first wafer second DMS plate and the second wafer second DMS plate in combination form a second differential mobility spectrometer, and the first wafer detector plate and the second wafer detector plate in combination form a detector. In an embodiment, the tandem differential mobility further comprises a port configured to introduce a vapor between the first differential mobility spectrometer and the field induced fragmentation stage.

In another embodiment, a chemical analysis method comprises isolating an ion from a sample with a differential mobility spectrometer, fragmenting the ion with an excitation stage, characterizing the ion with a second differential mobility spectrometer, and detecting the characterized ion with a detector.

In an embodiment, fragmenting the ion further comprises establishing an electric field in the excitation stage. In an embodiment, establishing the electric field further comprises creating a potential difference between a first strip and a second strip in the excitation stage.

In an embodiment, the method further comprises introducing a gas flow between the differential mobility spectrometer and the excitation stage. In an embodiment, the method further comprises providing energy at the excitation stage via an electric field, in order to facilitate a displacement reaction.

In an embodiment, the method comprises identifying a chemical from spectra provided by the detector. In an embodiment, identifying the chemical further comprises analyzing the spectra with a trained neural network.

It will be appreciated that variations of the above-disclosed and other features and functions, or alternatives thereof, may be desirably combined into many other different systems or applications. Also, it will be appreciated that various presently unforeseen or unanticipated alternatives, modifications, variations, or improvements therein may be subsequently made by those skilled in the art which are also intended to be encompassed by the following claims.

What is claimed is:

1. A detector system comprising:
a first analytical stage configured to isolate ions from a sample;
a field induced fragmentation stage configured to fragment the ions;
a second analytical stage configured to characterize the ions; and
at least one detector.

2. The detector system of claim 1 wherein the first analytical stage comprises:
a differential mobility spectrometer.

3. The detector system of claim 1 wherein the second analytical stage comprises:
a differential mobility spectrometer.

4. The detector system of claim 1 wherein the field induced fragmentation stage comprises:
a first strip and a second strip configured to create an electric field therebetween.

5. The detector system of claim 1 further comprising:
a port configured between the first analytical stage and the field induced fragmentation stage, configured to introduce a reagent.

6. The detector system of claim 1 further comprising:
an air purifier configured to purify a gas carrier for the sample, before the sample is delivered to the first analytical stage.

7. The detector system of claim 1 further comprising:
a driver configured to control an electric field of the field induced fragmentation stage.

8. The detector system of claim 1 wherein the detector comprises one of:
a faraday plate; or
a mass spectrometer.

9. The detector system of claim 1 wherein an output from the detector comprises a spectra sufficient for chemical identification.

10. The detector system of claim 9 wherein the spectra is analyzed using a neural network classification in order to identify constituent chemicals.

11. A tandem differential mobility spectrometer comprising:
a first wafer configured with:
a first wafer first DMS plate;
a first wafer FIF strip;
a first wafer second DMS plate; and
a first wafer detector plate;
a second wafer configured with:
a second wafer first DMS plate;
a second wafer FIF strip;
a second wafer second DMS plate; and
a second wafer detector plate;
a gasket between the first wafer and the second wafer; and
a frame configured to hold the first wafer and the second wafer.

12. The tandem differential mobility spectrometer of claim 11 wherein:
the first wafer first DMS plate and the second wafer first DMS plate in combination form a first differential mobility spectrometer;
the first wafer FIF strip and the second wafer FIF strip in combination form a field induced fragmentation stage;
the first wafer second DMS plate and the second wafer second DMS plate in combination form a second differential mobility spectrometer; and
the first wafer detector plate and the second wafer detector plate in combination form a detector.

13. The tandem differential mobility spectrometer of claim 12 further comprising:
a port configured to introduce a vapor between the first differential mobility spectrometer and the field induced fragmentation stage.

14. A chemical analysis method comprising:
isolating an ion from a sample with a differential mobility spectrometer;
fragmenting the ion with an excitation stage;
characterizing the ion with a second differential mobility spectrometer; and
detecting the characterized ion with a detector.

15. The chemical analysis method of claim 14 wherein fragmenting the ion further comprises:
establishing an electric field in the excitation stage.

16. The chemical analysis method of claim 15 wherein establishing the electric field further comprises:
creating a potential difference between a first strip and a second strip in the excitation stage.

17. The chemical analysis method of claim 14 further comprising:
introducing a gas flow between the differential mobility spectrometer and the excitation stage.

18. The chemical analysis method of claim 14 further comprising:
providing energy at the excitation stage via an electric field, in order to facilitate a displacement reaction.

19. The chemical analysis method of claim 14 further comprising:
identifying a chemical from spectra provided by the detector.

20. The chemical analysis method of claim 19 wherein identifying the chemical further comprises:
analyzing the spectra with a trained neural network.
